(19) United States
(12) Patent Application Publication
(10) Pub. No.: US 2012/0059701 A1
(43) Pub. Date: Mar. 8, 2012

(54) SYSTEMS AND METHODS FORFACILITATING A REWARDS PROGRAM INVOLVING MULTIPLE PAYMENTS ACCOUNTS

(76) Inventors: Larry van der Veen, San Carlos, CA (US); Charles Marshall, Atherton, CA (US); Paul Spaeth, Half Moon Bay, CA (US)

(21) Appl. No.: 12/953,051

(22) Filed: Nov. 23, 2010

Related U.S. Application Data
(63) Continuation-in-part of application No. 12/578,225, filed on Oct. 13, 2009.
(60) Provisional application No. 61/263,793, filed on Nov. 23, 2009.

(51) Int. Cl. G06Q 30/02

(52) U.S. Cl. 705/14.17

(57) ABSTRACT

Systems and methods are provided for linking multiple payment card accounts to a single rewards program account which include associating, in a program management computer system, a first program identifier with the single rewards program account, associating, in the program management computer system, the first program identifier with a first payment card account, associating, in the program management computer system, the first program identifier to at least a second payment card account; and storing, in the program management computer system, at least a first set of reward program rules associated with the single reward program account, the first set of reward program rules specifying at least one of a reward conversion ratio and a promotion rule. Payment transactions conducted using the first and at least second payment card accounts earning a reward amount are associated with the single rewards program account and the first set of reward program rules are applied to the payment transactions.

### RELATED APPLICATIONS

This application claims benefit of and priority to U.S. Provisional Patent Application Ser. No. 61/263,793, filed Nov. 23, 2009, and is a continuation in part of U.S. patent application Ser. No. 12/578,225, filed Oct. 13, 2009, the contents of each of which are hereby incorporated by reference in their entirety for all purposes.

### FIELD

The present invention relates to systems and methods for facilitating a rewards or loyalty program involving multiple payment accounts and, more particularly, to systems and methods for associating multiple payment accounts with a single rewards account and processing rewards accumulation and redemption transactions involving multiple payment accounts associated with a single rewards account.

### BACKGROUND

Rewards programs are a common feature of today's business landscape. Numerous institutions, including banks and credit card companies, airlines, hotels, retailers and manufacturers now offer rewards to their customers in order to promote the loyalty of these customers towards the company's products and services. Generally these programs reward customers for repeat purchases of a company's products by enabling the customer to earn loyalty points on purchases which can then be redeemed for goods and services selected from a redemption catalog or for discounted or free products and services on future purchases. The reward points earned are usually based upon a formula that relates a customer's purchase amount to a specified number of points. An example is a rewards program that awards points on a one-for-one basis with each dollar that a customer spends on particular goods and services.

A common means for earning rewards points is through spending on a payment card. Nearly all of the major financial institutions today offer multiple types of rewards cards that allow cardholders to accumulate and redeem loyalty points in accordance with the volume of purchases made with the card. Rewards programs are popular features of both credit and debit cards and are offered in connection with a wide variety of consumer, small business and corporate card accounts. These programs are designed to induce increased spending on the card issuer's card products and to motivate cardholders to consolidate their purchases onto a single card issued by the rewarding financial institution, often in conjunction with its business partners.

While rewards programs have become an accepted feature of many payment card offerings in today's marketplace, they continue to operate as programs linked to a single payment card account. For example, today's small business rewards credit cards allow for earning and redeeming rewards based upon the spending associated with that particular card but do not allow for the accumulation and redemption of rewards based upon spending associated other small business card products such as, for example, a payroll card or a tax-advantaged Health Reimbursement (“HRA”) card. In these cases, separate rewards programs might exist for each card product, but a means for enabling a shared rewards program to operate across multiple distinct card products is lacking.

A program which enables such a sharing of rewards across multiple payment products is desirable because it allows card issuing institutions to more tightly integrate distinct card products into more unified business solutions. For example, with such ability an institution that offers credit cards, debit cards, HRA cards and payroll cards to small businesses could provide these businesses with a suite of products linked together under a single shared rewards program. Businesses would benefit from such programs because spending on each product would contribute towards the same rewards account balance and allow the business to more rapidly accumulate and consolidate points for redemption. Card issuing institutions would benefit from the incentives provided for businesses to establish multiple card product relationships with that institution.

There is thus a need in the art for a system and methods which provide a unified rewards program capable of aggregating and enabling redemption of rewards and incentives across a plurality of payment card product types.

### SUMMARY

In order to overcome the deficiencies in the prior art, the present invention introduces systems and methods for enrolling multiple payment cards in a single rewards account and processing transactions involving multiple payment accounts associated with a single rewards account, including rewards accumulation and redemption.

Pursuant to some embodiments a rewards account including multiple associated payment card accounts is provided. Pursuant to some embodiments, rewards accounts are associated with multiple payment accounts using a rewards program identifier common to each of the payment accounts and to the rewards account but otherwise unique to a rewards program. Pursuant to some embodiments, purchases using payment card accounts associated with a single rewards account earn rewards, loyalty points or the like based upon the aggregated spending or purchase volumes conducted with these payment card accounts. Pursuant to some embodiments, the types of rewards and the eligible payment cards associated with the rewards program account are defined and established by reward sponsoring entities, such as, for example, the operator of the program management system, the issuer of the payment accounts, the issuer of the rewards account, merchants, manufacturers, financial institutions, or payment card processors or issuers.

As an example of a system that may be provided pursuant to the present invention, a card issuing institution, such as a bank, may form a rewards program for small businesses under which it issues a suite of payment cards for small businesses, such as, for example, a small business credit card, a payroll card and a health reimbursement account card, all of which the system associates with a single and common rewards program. The system may assign each of the payment card accounts and the rewards program account an identical rewards program identifier that is otherwise unique to the system. The common program identifier provides a means by which the payment cards may be associated with a single rewards program account within the system. The system enables the issuance of access devices associated with the payment accounts, such as, for example, payment cards, to account holders, such as, for example, small businesses and/or their employees for purposes of making purchases on behalf of the company, distributing payroll or providing tax-advantaged contributions to a health care account. The rewards available under such a rewards program may be provided, for example, by merchants such as a drug retailer which offers loyalty points on the basis of one loyalty point for each ten dollars of spending on any of the cards in the payment account suite at the drug retailer's stores. The drug retailer may also define rules for rewards redemption such as, for example, allowing loyalty points to be spent on a one for one basis on selected categories of the drug retailer's products. For each purchase transaction conducted with an account belonging to the payment card suite, the system converts the purchase amount to reward units (in this example loyalty points) using the conversion ratio associated with the program (in this example one point for each ten dollars of spending). The system then adds these reward units to the total reward units in the rewards program account balance associated with the card suite. By aggregating reward units across multiple card types in this way reward units can more rapidly accumulate towards redemption thresholds.

The system also provides methods for the redeeming of the rewards account balance by enabling the owner of the rewards program account to access the reward units for spending on eligible purchases. Referring to the above example, the small business, as the rewards account holder, may be issued a separate loyalty card which can be used for making purchases of products eligible for redemption under the rewards program rules. When presented to the drug retailer at the time of purchase, the loyalty card accesses the reward account balance and the system debits this balance for an amount equal to the purchase price of the products.

### BRIEF DESCRIPTION OF THE DRAWINGS

FIG. 1 is a schematic block diagram illustrating a system that may be provided according to some embodiments of the present invention.

FIG. 2 is a schematic block diagram illustrating details of an exemplary program management system according to some embodiments of the present invention.

FIG. 3 is a flow diagram illustrating an exemplary process for enrolling payment card accounts into a shared rewards program.

FIG. 4 is a flow diagram illustrating an exemplary process for processing rewards transactions conducted with payment cards belonging to a shared rewards system.

FIG. 5 is a flow diagram illustrating an exemplary process for redeeming rewards transactions from a shared rewards system.

### DETAILED DESCRIPTION

In general, the methods and systems of the present invention facilitate the creation of loyalty and other forms of customer rewards programs that can be accessed and shared by a plurality of payment card accounts.

The detailed description of various embodiments of the invention that follows makes reference to the accompanying drawings, which depict embodiments by means of illustration. These embodiments are described in sufficient detail to enable those of ordinary skill in the art to practice the invention, but it can be appreciated that other embodiments may be realized and that logical, physical and mechanical changes may be made without departing from the spirit and scope of the invention. The following detailed description is therefore presented for illustration purposes only, and should not be construed as imposing limitations on the nature or scope of the disclosed invention. The scope of the invention is defined solely by the appended claims when read properly in the context of the following description.

Pursuant to some embodiments, a rewards account associated with multiple payment accounts is provided wherein purchases or other forms of spending associated with each payment account are converted into reward units and combine and accumulate in a single rewards account. Pursuant to some embodiments the reward units in the rewards account may then be redeemed by the rewards account holder or any agent or other entity authorized by the rewards account holder to redeem the reward units in the rewards account.

With these and other advantages and features of the invention that will become hereinafter apparent, the invention may be more clearly understood by reference to the following detailed description of the invention, the appended claims, and the drawings attached herein.

For the purposes of describing features of embodiments of the present invention, a number of terms are used herein. For example, the term “account access device” is used to refer to a token, card or other device that is associated with a payment account pursuant to the present invention and which is issued to an account holder (such as an insured consumer or business). An account access device may be provided in any of a number of different forms, including as a standard ISO 7816 magnetic stripe card (such as a debit card, credit card, stored value card, prescription card, medical card, or the like) as an RFID chip encapsulated in a card or other device, as a chip or application embodied in a smart phone or PDA, or as a virtual account number so long as the account access device identifies (or allows identification of) an associated account.

As used herein, the term “product” is used to refer to physical products or goods as well as services.

As used herein, the term “payment account” is used to refer to an account established for facilitating transactions associated with the recording, transfer and storage of value, and include credit, debit, stored value, health care benefit, health reimbursement, mortgage, flexible spending, health savings, or medical savings accounts, and/or the like. A payment account may be issued in the name of, or on behalf of, individuals, groups of individuals, businesses, proprietorships, partnerships, corporations, non-profit groups, government organizations, and/or the like.

Pursuant to some embodiments, a “payment account” as used herein may be or include a consumer payment account that may be used in conjunction with transactions involving multiple product categories as described in our co-pending and commonly assigned U.S. patent application Ser. No. 12/578,225. For example, pursuant to some embodiments, reward points and transactions may be calculated, earned or otherwise redeemed in conjunction with payment transactions involving a payment account having multiple subaccounts, each having one or more permitted product categories that may be purchased using funds from each subaccount. Some or all of the subaccounts may be associated with one or more redemption rules or conversion ratios, thereby allowing reward transactions to be based on product categories or types.

As used herein, the term “rewards account” is used to refer to an account established for facilitating transactions associated with the recording, storage, accumulation and redemption of rewards units.

As used herein, the term a “rewards unit” is used to refer to any denomination of rewards or loyalty value, including loyalty points, discounts, rebates, dollars, foreign currencies, coupons, gift certificates, bonus points, credits or debits to a financial instrument, and/or the like.

As used herein, the term “merchant” is used to refer to any person, website, physical location, retailer, manufacturer, distributor, financial institution, issuer, acquirer, consumer, hardware, software, or any other entity that desires to participate in the system.

As used herein, the term “rewards sponsor” is used to refer to any person, website, physical location, retailer, manufacturer, distributor, financial institution, issuer, acquirer, consumer, hardware, software, or any other entity that desires to provide rewards units to the system

It should be understood that any number of individuals, merchants, manufacturers, businesses, rewards sponsors, system providers and the like may participate in the systems and methods of the present invention.

The system described herein may include host servers or other computing systems equipped with processors, memory, connecting buses, network interfaces and storage devices, and may further include hardware and/or software systems used for purposes such as providing system and information security, system monitoring, troubleshooting, reporting or the like. Those of ordinary skill in the art will be acquainted with the various forms of software, hardware, memory systems, operating systems, computer processors, storage devices, input/output display devices, communication networks and interfaces that may be used to provide the present invention. And though the systems described herein are generically described with reference to block and functional diagrams, these diagrams are provided purely for illustration of some of the embodiments of the present invention and should not be construed to limit the scope or types of hardware, software or other means of providing the system. Moreover, those of ordinary skill in the art will appreciate that the present invention may be embodied as a single or multiple methods, as an entirely software embodiment, an entirely hardware embodiment or an embodiment combining aspects of both software and hardware.

Prior to describing the features of the present invention in detail, an illustrative example will first be introduced. This example is purely for illustration of certain features of some embodiments. In the example, a bank (“Big Bank”) creates three payment card accounts (a Credit Card account, a prepaid Health Reimbursement Account and a prepaid Payroll Card account) and one rewards program account on behalf of a small business (“Small Biz”). Each of the three payment card accounts is associated with the rewards program account by, for example, assigning each of the accounts an identical program identifier. The identifier may be any symbol, indicia, code, number, or other identifier which can be used to couple accounts. In this example program identifier is the rewards program account number. Big Bank issues at least one payment account access device to Small Biz and its employees for each of the payment card accounts. In this example, the access device is a magnetic stripe card with a card body embossed with the names of Small Biz and the employee and a primary account number or “PAN” and with a magnetic stripe storing card data. A rewards sponsor agrees to provide reward units associated with the rewards program account that can be earned or accumulated in relation to the spending associated with each of the payment accounts. A rewards sponsor may impose rules and conditions on the accumulation and redemption reward units, such as, for example, the categories of purchases eligible for earning rewards, the ratio at which purchase amounts are converted to rewards units and the rules and ratios by which reward units may be redeemed for other forms of value. It should be noted that accumulation rules, promotion rules and conversion ratios may be unique to each program identifier. In this example, the rewards sponsor is a drug retail chain (“Drug Store”) that specifies a rewards program which, on the combined spending of up to $500 associated with the three payment accounts at Drug Store's locations in a calendar year, provides one loyalty point for each ten dollars of spending. In addition, on combined spending of more than $500 associated with spending from these payment accounts at its locations, Drug Store provides two loyalty points for each ten dollars of spending. Drug Store further specifies that loyalty points may be redeemed for any products or services at the company's locations on a one dollar per one loyalty point basis. Each of the payment cards may also be used for purchases at locations not affiliated with Drug Store, but no rewards are earned or accumulate on these transactions under this particular program. To access the rewards account for redemption, an access device may be provided by the rewards sponsor, the card issuing institution or any of their agents or processors or another third party. In this example, Big Bank issues a separate loyalty card (a magnetic stripe card with a card body embossed with the names of Small Biz and Drug Store, the Small Biz rewards account number and a magnetic stripe storing card data, including the rewards account identifier and/or account number).

Pursuant to some embodiments, employees may use their account access devices at merchant locations and purchase products and services for business or personal use. In this example, Small Biz employees use their Small Biz credit cards at Drug Store for spending $300 on office supplies for the company, their Small Biz payroll card for spending $200 on personal items and their Health Reimbursement Account cards for spending $200 on personal prescription drugs. The purchase amounts are converted to 90 loyalty points (using the program's conversion ratio of one point for each $10 of spending on the first $500 of combined spending and two points for each $10 of spending above $500). These loyalty points are then added to the rewards program account balance. In this instance, the $800 of total purchases on the cards is converted to 80 loyalty points which are added to the rewards program balance. These 80 loyalty points are then redeemable for $80 worth of merchandise or other products or services at Drug Store locations using the Small Biz loyalty card.

By combining the spending of the three payment cards into a single rewards account, Small Biz can more rapidly reach the rewards threshold of $500 in spending, at which point the company doubles the number of loyalty points it receives for each dollar of card spending. The rewards program of this illustrative example will be followed throughout the remainder of this disclosure as a means to provide a specific example of some features of the present invention.

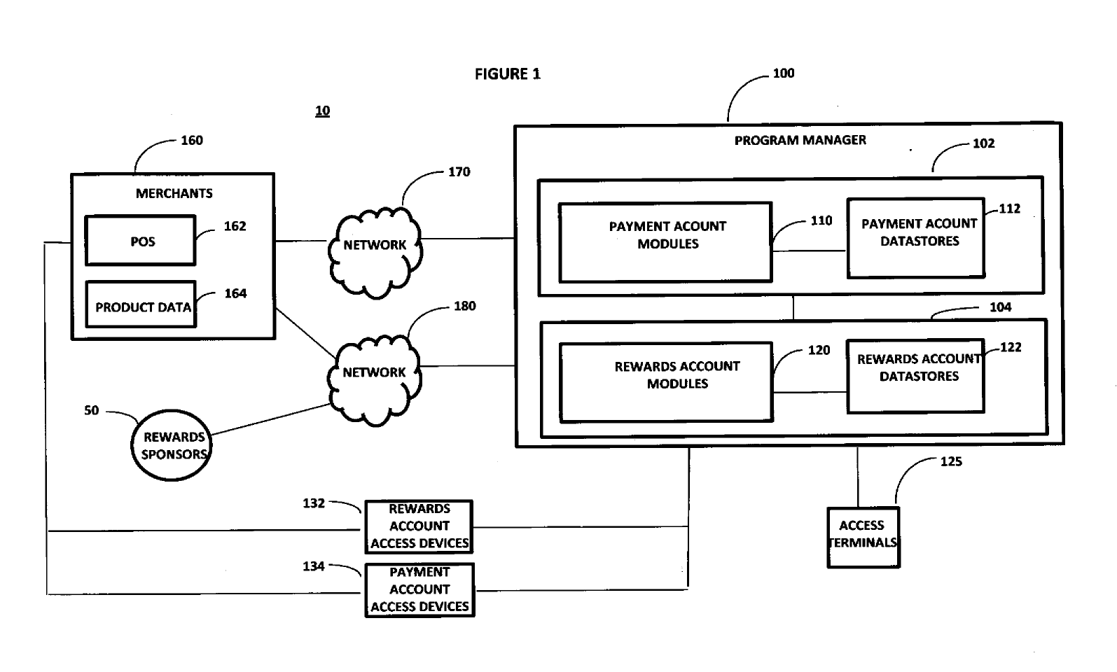

Turning now in detail to the drawings, FIG. 1 is a block diagram representation of a rewards system 10 that may be provided according to some embodiments. The system 10 includes a program management system 100 in communication with other devices and systems via several communications networks including a first communication network 170 and a second communication network 180. The program management system may be operated by, or associated with, for example, a financial institution, a payment card processor, a merchant processor a loyalty card processor or other such companies or services that issue rewards or payment accounts pursuant to the present invention to individuals or businesses (although those skilled in the art will appreciate that the inventive accounts may also be issued to entities such as groups of individuals, nonprofit organizations, government agencies or the like). In some embodiments the program management system may be operated by or associated with a company that offers rewards or other forms of loyalty value to individuals and businesses, such as, for example, a merchant, a merchant processor, a service provider or a product manufacturer.

The program management system 100 is in communication with a number of other devices, including one or more merchant systems 160 and one or more rewards sponsors 50. It can be appreciated by those skilled in the art that program management system 100 may be in communication with a large number of merchants and a large number of rewards sponsors (and that there may be multiple program management systems). Merchant system 160 includes a number of modules or devices, including, for example, one or more point of sale devices 162 and one or more product datastores 164. Point of sale device 162 includes apparatus to facilitate purchase transactions, such as, for example, a cash register, a magnetic stripe card reader, a smart card reader, a bar code scanner and/or the like. In one embodiment, POS device 162 includes a display or printing device configured to display and/or print rewards account information in accordance with the present invention. In one embodiment, POS device 162 includes or is in communication with product datastores 164 for maintaining and storing purchase data and rewards data, such as, for example, products or categories eligible for rewards accumulation and redemption.

Rewards sponsors 50 may be external (or, in some embodiments, internal) sources of rewards value supplied to the rewards program accounts. In some embodiments, rewards sponsor 50 and merchant 160 are identical. In some embodiments, rewards sponsor 50 is a manufacturer which provides rewards in connection with the purchasing of particular products as identified by, for example, a UPC code, a SKU number or other indicia used to uniquely identify products and/or their associated manufacturer.

Pursuant to some embodiments, the program management system 100 includes a number of components or modules, several of which are shown in FIG. 1 and include payment account system 102 and rewards account system 104. Payment account system 102 includes payment account modules 110 and payment account datastores 112. Rewards account system 104 includes rewards account modules 120 and rewards account datastores 122. As will be described in further detail below, the payment account system 102 includes data, logic and rules for establishing payment card accounts, issuing payment card account access devices and processing payment card transactions including, for example, transaction authorization, clearing and settlement. Rewards account system 104 includes data, logic and rules for establishing rewards program accounts, associating rewards program accounts with payment card accounts, issuing rewards account access devices and processing transactions associated with rewards program accounts, including, for example, reward units accrual, conversion and redemption transactions. In some embodiments, the program management system 100 includes an access terminal 125 which can be used by rewards account holders to interact with the program management system for such purposes as, for example, determining rewards balances, inputting or outputting data, updating account profile information or receiving customer service. Access terminal 125 may be in communication with program system 100 using several known communication networks (not shown), such as, for example, those described below with reference to communication networks 170, 180.

Pursuant to some embodiments, the payment account system 102 and the rewards account system 104 of program management system 100 are operated by a single entity, such as, for example, a bank, account processor or the like. Pursuant to some embodiments the payment account system 102 and the rewards account system 104 are operated by separate entities, functioning cooperatively as a rewards program management system 100. For example, rewards account system 104 may be operated by a rewards sponsor while the payment account system 102 may be operated by, for example, a bank, a card processor or other institution.

As used herein, devices and systems (including the program management devices and systems 100, 102, 104, the merchant devices and systems 160, and the rewards sponsor devices and systems 50 may communicate, for example, via communication networks 170 and 180 such as Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a cable television network, or an Internet Protocol (IP) network such as the Internet, and intranet or an extranet. Moreover, as used herein, communications include those enabled by wired or wireless technology. In some embodiments, one of the networks 170 is an open loop payment card network such as the Bank Net network operated by MasterCard International Incorporated, or the VisaNet network operated by Visa International Service Association, or the networks branded as NYCE, STAR, or the like. In some embodiments, one of the networks 170 is a closed loop payment card network such as those operated by American Express, Discover or the National Association of Automated Clearinghouses (NACHA). In some embodiments, network 170 is a closed loop, private label network.

In further reference to FIG. 1, pursuant to some embodiments, the program management system facilitates access to payment account data 112 and rewards account data 122 using access devices 132, 134. In one embodiment, a plurality of rewards accounts and payment accounts may be issued to one or more account holders, such as for example, small businesses or individuals, where each payment account is associated with one or more rewards account in accordance with the teachings of the present invention, as will be discussed below.

An access device such as, for example, a payment card may be issued to a payment account holder by system 100 for purposes of making purchases at merchants. Likewise, a separate access device such as, for example, a loyalty card may be issued to a rewards account holder by system 100 for purposes of redeeming rewards at merchants or reward sponsors. Pursuant to some embodiments, access to the rewards account and the payment account is accomplished with a single access device, such as, for example, a payment card embedded with both rewards and payment account data, and where, for example, the redeeming merchant or sponsor has enabled its systems to accept a single access device capable of accessing both a rewards account and a payment account.

Referring to our illustrative example, Big Bank may establish a rewards account wherein the rewards sponsor, Drugstore, supplies reward units to rewards accounts based upon spending by associated payment accounts at Drugstore locations. Big Bank establishes credit card, Health Reimbursement Account and Payroll card accounts on behalf of Small Biz and issues payment cards associated with each account to Small Biz for facilitating purchases by Small Biz and its employees. Big Bank in turn associates each payment card account to the rewards account using a common rewards program identifier, in this case the rewards account number.

Reference is now made to FIG. 6, which is a portion of a tabular representation of a rewards account datastore 600 and a payment account datastore 700 that may be provided at system 100 according to some embodiments of the present invention. In some embodiments, table 600 and table 700 are stored in a single database. In some embodiments, table 600 and table 700 are stored in separate databases. Table 600 includes entries identifying rewards accounts that have been established (or that may be established or issued) to account holders so that they may accumulate and redeem rewards using associated payment accounts and corresponding access devices pursuant to the present invention. Table 700 includes entries identifying payment accounts that have been established (or that may be established or issued) so that they may utilize access devices pursuant to the present invention.

Table 600 defines fields 602, 604, 606, 608, 610, 612, 614 and 616 for each entry. The fields specify a rewards program account number 602, a rewards program identifier 604, an account holder profile 606, a rewards sponsor profile 608, an account balance 610, conversion rules 612, promotion rules 614 and redemption rules 616.

The rewards account identifier 602 may be, for example, an alphanumeric identifier uniquely identifying a particular rewards account.

The rewards program identifier 604 may be, for example, an alphanumeric identifier uniquely identifying a particular rewards program. In some embodiments, the rewards program identifier 604 is identical to the rewards account identifier 602. In some embodiments, the rewards program identifier 604 is distinct from the rewards account identifier 602. In some embodiments, the rewards account 602 may be associated with more than one rewards program identifiers, as, for example, where more than rewards sponsors contribute reward units to the rewards account under separate rewards programs, or a single rewards sponsor associates more than one rewards programs to the rewards program account.

The account holder profile 606 may include information pertaining to the identity of the account holder (or account holders) including, for example, name (individual or business), address, phone numbers, fax numbers, email addresses, website, primary and secondary contacts, and the like.

The rewards sponsor profile 608 may include information pertaining to the identity of the rewards sponsor (or rewards sponsors) including, for example, name (individual or business), address, phone numbers, fax numbers, email addresses, website, primary and secondary contacts, and the like.

The account balance 612, may include the current reward units account balance and may include, for example, the total reward units, the total number of purchases, the total number of purchases by merchant location, the total number of items purchased by product or product category, and the like.

The conversion rules 612 may include rules by which spending by each payment account associated with a rewards account is converted to reward units, and may include, for example, conversion ratios, formulas, algorithms, or the like. The conversion rules may also include rules which specify which spending data are convertible into rewards units, such as, for example, total purchase amount, total number of purchases, total purchase amount of a specified product (or products), total number of purchases of a specified product (or products), and the like.

The promotion rules 614 may include rules by which specific reward units may be earned and may include, for example, dates and times of reward unit eligibility, the types of accounts under which reward units may be earned, the types of reward units that may be earned under each type of account, and the like.

The redemption rules 616 may include rules by which reward units balances may be redeemed, such as, for example, conversion ratios, formulas, algorithms or the like. Redemption rules may also specify the denominations or form of redemption of rewards units, such as, for example, discounts, merchandise, cash, gift certificates, rebates, credits or debits to a financial instrument, and the like.

Table 700 defines fields 702, 704, 706, 708, 710, 712, 714 and 716 for each entry. The fields specify a payment account identifier 702, a rewards program identifier 704, and account type 704, an account holder profile 708, an account balance 710, and other data 712.

The account identifier 702 may be, for example, an alphanumeric identifier uniquely identifying a particular payment account.

The rewards program identifier 704 may be, for example, an alphanumeric identifier uniquely identifying a particular rewards program and corresponds to a program identifier 604 assigned to a rewards program account.

The account type 706 may be, for example, an alphanumeric identifier that identifies the type of payment account such as, for example, an individual checking account, a small business credit account, an HRA account, a payroll card account, and the like.

The account holder profile 706 may include information pertaining to the identity of the account holder (or account holders) including, for example, name (individual or business), address, phone numbers, fax numbers, email addresses, website, primary and secondary contacts, etc.

The account balance 708 may include the amount of the current balance of the account and may include, for example, the debit or credit balance in the account. The account balance may be denominated in dollars, foreign currencies or the like.

Other data 710 may include information such as, for example, the amount of credit available to spend, security information, processing parameters or other information necessary to establish payment accounts and process payment transactions.

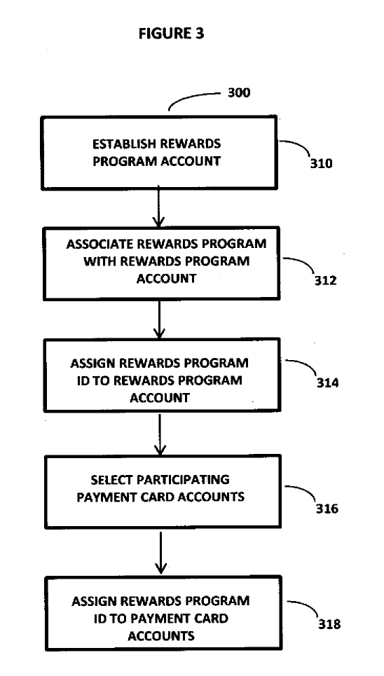

Reference is now made to FIG. 3 which is a flow diagram that illustrates a method for coupling payment accounts to rewards accounts that may be performed according to some embodiments. The flow chart in FIG. 3 and the other figures described herein do not imply a fixed order to the steps, and embodiments of the present invention can be practiced in any order that is practicable. Moreover, the method or methods may be performed by different parties. Moreover, any single element might be performed by multiple parties.

Process 300 begins at step 310 where a rewards account pursuant to the present invention is established at system 100. For example, processing may begin when a reward sponsors, such as, for example, a merchant and/or a bank, initiate a rewards program designed to incent small businesses to subscribe to a set of small business card products issued by the bank and designed to promote spending at the merchant. Rewards program data may be communicated to the Bank from the merchant or the rewards sponsor over network 180.

At 312 the program manager associates rewards program policies, rules and related information, such as, for example, promotion rules, the payment accounts eligible for participation in the rewards program, the conversion rules, the redemption rules, and the like.

At 314 a rewards program identifier is assigned to the rewards program account.

At 316 payment accounts are selected for inclusion or participation in the rewards program, including, for example, payment accounts that have been established and issued or those to be established and issued.

At 318 a rewards program identifier corresponding to the rewards program identifier of step 312 is assigned to each payment account.

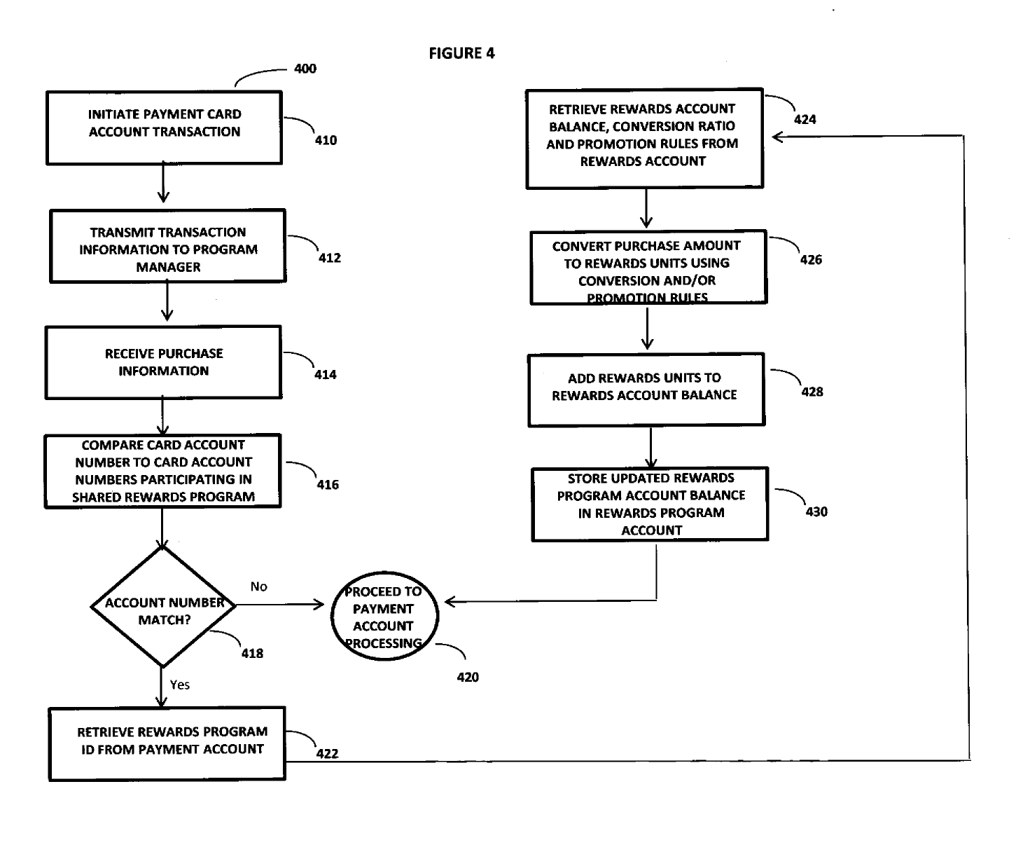

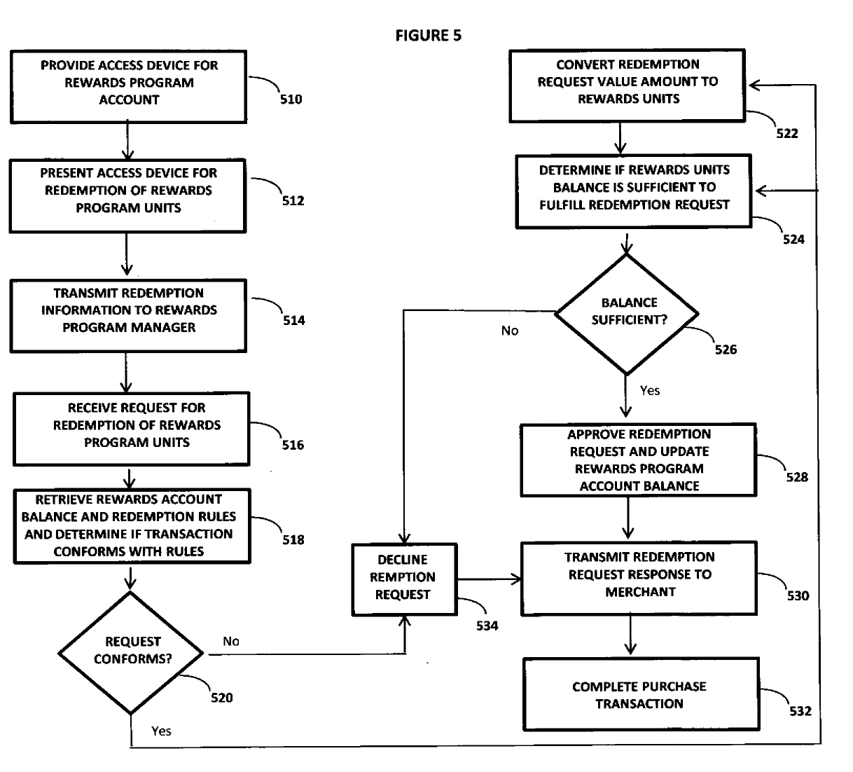

Reference is now made to FIG. 4 which is a flow diagram that illustrates a method for processing rewards transactions that may be performed according to some embodiments.

Process 400 begins at step 410 where a transaction involving a payment account issued pursuant to the present invention is initiated at a merchant. For example, processing may begin when an account holder presents an account access device at a merchant point of sale terminal along with one or more products to purchase. Processing at 410 includes identifying a payment account number (e.g. by reading a magnetic stripe, or otherwise detecting an account number associated with an account access device).

Processing continues at 412 where the merchant transmits the transaction information, including, for example, the purchase amount, the number of items purchased, product identifiers, merchant identifying information, the payment account identifier, and the like using network 170.

Processing continues at 414 where the program manager receives the purchase information and at 416 performs a comparison of the payment account identifier to the payment account identifiers associated with rewards accounts pursuant to the present invention to determine at 418 if the payment account is eligible for participation in a rewards account program by, for example, determining the presence of a valid rewards program identifier associated with the payment account in the payment account datastore. If the payment account is not eligible for participation in a rewards account program, the process continues at 420 where the transaction is processed as a non-rewards payment account transaction.

If the payment account is determined to be associated with a rewards account, processing continues at 422 where the rewards program identifier is retrieved from the payment account datastore. At 424 the rewards account balance, conversion rules, and promotion rules are retrieved from the rewards account datastore using, for example, the rewards program identifier of step 422.

Processing continues at 426 where the transaction purchase amount is converted into rewards units according to the conversion and/or promotion rules retrieved from the rewards account.

Processing continues at 428 where the reward units balance retrieved from the reward units account is updated with the rewards units calculated at 426 and at 430 is then stored in the reward units account.

Processing continues at 420 where the transaction is further processed as a payment account transaction.

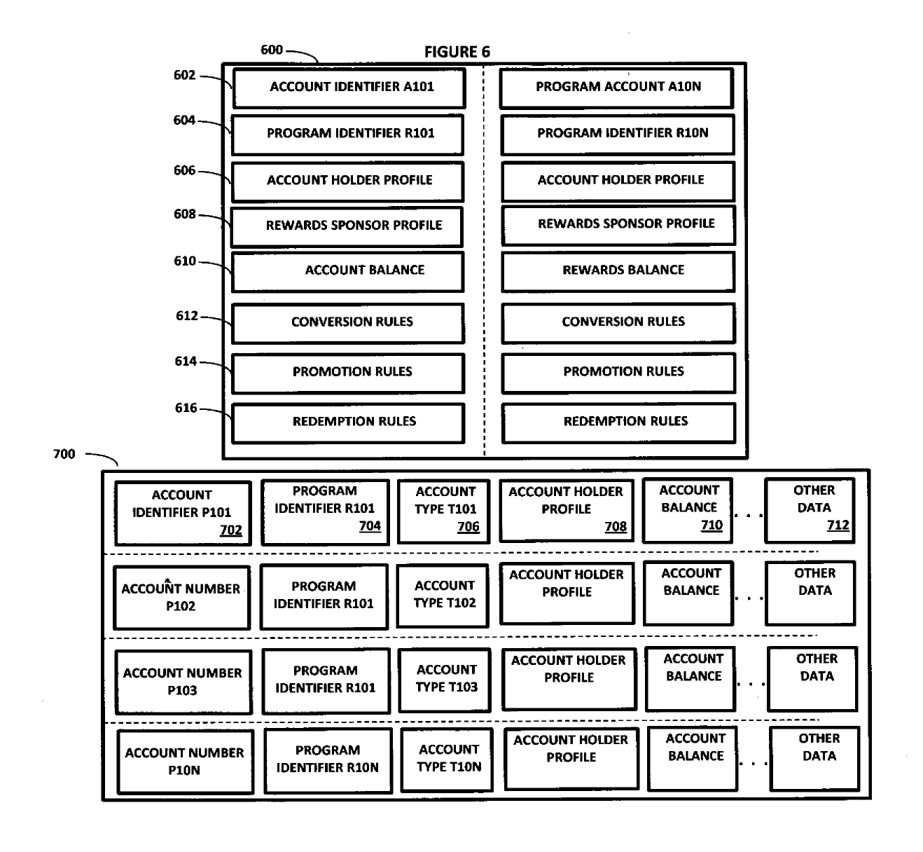

Reference is now made to FIG. 5 which is a flow diagram that illustrates a method for redeeming rewards that may be performed according to some embodiments.

Process 500 begins at step 510 where a rewards account access device, such as, for example, a loyalty card containing a rewards account number pursuant to the present invention, is provided to the rewards account holder (including any authorized agents of the rewards account holder) to access the rewards account balance for redemption of rewards.

At 512 the access device is presented for redemption at, for example, a merchant participating in the rewards program as a rewards sponsor. For example, the access device may be presented by a rewards account holder to a merchant for the purpose of receiving a discount on a purchase or to receive free merchandise.

At 514 the merchant transmits the redemption request to the program manager, including, for example, the purchase value of the merchandise to be redeemed, merchant identifying information, and the rewards account identifier (for example, the rewards account number).

At 516 the program manager receives the redemption request and at 518 retrieves the rewards program rules and the rewards account balance from the rewards accounts datastore using the rewards account number and then determines if the redemption request conforms to the redemption rules associated with the rewards account.

If at 520 the redemption request is determined not to conform to the redemption rules, processing continues at 534 where the rewards redemption is request is declined and a redemption response message is created.

If at 520 the redemption request is determined to conform to the redemption rules, processing continues at 522 where the redemption request value is converted to rewards units using, for example, the redemption conversion ratio associated with the rewards account.

Processing continues at 524 where the converted redemption rewards units are compared to the reward units balance in the rewards account to determine if the rewards units balance is sufficient to redeem the redemption request. If at 526 the rewards balance is insufficient to redeem the redemption request, processing continues at 534 where the redemption request is declined and a redemption response message is created.

If at 526 the rewards balance is sufficient to redeem the redemption request, processing continues at 528 where the redemption request is approved and a redemption response message is created. In addition the rewards account balance is updated to reflect the amount of rewards units redeemed.

Processing continues at 530 where the redemption response message is transmitted to the merchant where at 532 the merchant completes the transaction by, for example, either applying the redemption amount to the amount of the purchase or requesting a separate form of payment tender.

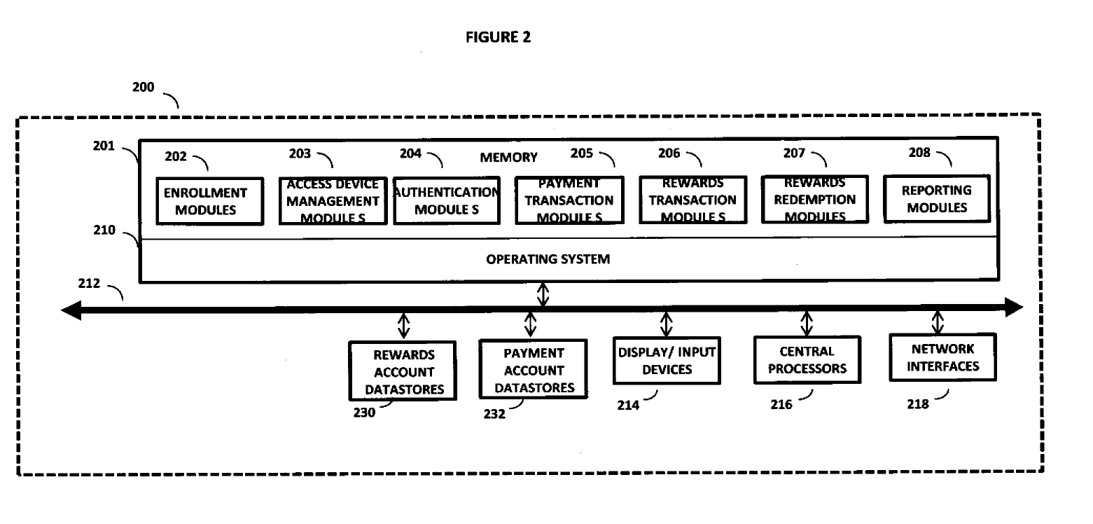

Reference is now made to FIG. 2 which is a block diagram representation that illustrates in detail a program management system that may be provided according to some embodiments of the present invention.

In general program management system 200 maintains one or more rewards accounts and one or more payment accounts for each participating business or consumer. In addition, the rewards modules of system 200 manage the rewards portion of system 10, and the payment modules of system 200 manage the payment portion of system 10. In some embodiments program management system 200 receives, processes and/or stores data in the applicable datastores 230, 232. The program management system 200 may receive and process information from merchant systems 160, reward sponsor systems 50 and access terminals 125. Rewards system 200 may also associate multiple payment accounts and multiple rewards programs to a particular rewards account. In some embodiments, the program management system performs an analysis involving some or all of the following: purchase transaction data, such as, for example purchase amounts and product identifiers; rewards account data, such as, for example, rewards account identifiers, account balances and transaction activity; rewards program data, such as, for example, conversion ratios, promotion rules and redemption rules; and payment account data, such as, for example, payment account identifiers, payment account balances and transaction activity. The datastores discussed herein, such as for example, 164, 112, 124, 230, 232, 600, 700, may be any type of database, such as relational, hierarchical, object-oriented, or the like. Datastores may employ the use of data tables that can be merged using, for example, key fields.

In further reference to FIG. 2, some embodiments of a program management system 200 may include a central processor 216 in communication with other elements of the program management system through a system interface or bus 212. Suitable display/input/output devices 214 such as, for example, keyboards, monitors and printers, may be provided for receiving or outputting data from and inputting data to the program management system 200. Computer memory 201 associated with the program management system 200 may include software modules to facilitate the execution of program management system 200, such as, for example, enrollment modules 202 for enrolling rewards and/or payment account holders, rewards sponsors, rewards and/or payment account programs, rules, parameters and the like; authentication modules 204 for authenticating users and/or participants; access device management models 202 for facilitating the issuance of access devices (for example, cards); rewards transaction modules 206 for facilitating the processing of rewards account transactions; rewards redemption modules 207 for facilitating the processing of rewards account redemption transactions; payment transaction modules 205 for facilitating the processing of payment account transactions; and reporting modules 208 for generating information and data for reporting to program management system participants, including, for example, system operators, rewards sponsors, merchants, account holders, and government agencies. Computer memory 201 may also include an operating system 210 which enables execution by processor 216 of the various software modules described herein. A network interface 218 may be provided for suitably interfacing with other elements of the rewards system 10, such as, for example, the elements described herein with reference to FIGS. 1, 3, 4, 5 and 6.

What is claimed is:

1. A computerized method for linking multiple payment card accounts to a single rewards program account, the method comprising:
associating, in a program management computer system, a first program identifier with said single rewards program account;
associating, in said program management computer system, said first program identifier with a first payment card account;
associating, in said program management computer system, said first program identifier to at least a second payment card account; and
storing, in said program management computer system, at least a first set of reward program rules associated with said single reward program account, said first set of reward program rules specifying at least one of a reward conversion ratio and a promotion rule;
wherein payment transactions conducted using said first and at least second payment card accounts earning a reward amount are associated with said single rewards program account and said first set of reward program rules are applied to said payment transactions.

2. The method of claim 1 wherein said first and at least second payment card accounts each include at least one of a credit card account, a debit card account, a savings account, a stored value account, a health reimbursement account, a health savings account, or a flexible savings account.

3. The method of claim 1 wherein said first and at least second payment card accounts are held by an individual.

4. The method of claim 1 wherein said first and at least second payment card accounts are held by a proprietary small business, partnership, corporation, non-profit or government entity or any employees of said entities.

5. The method of claim 1 wherein a payment card is issued that is associated with said first payment card account, said payment card at least one of a plastic card embedded with a magnetic stripe, a smart phone, a PDA, a smart card, or a virtual card.

6. The method of claim 1 wherein said single rewards program account is configured to accrue rewards in the form of at least one of loyalty points, discounts, and monetary credits.

7. A computerized method for processing rewards transactions initiated by at least a first and a second payment card account associated with a single rewards program account, the method comprising:
receiving, from a merchant, data associated with a first transaction completed using a first payment card account, said data including a merchant identifier, a purchase amount, and a first payment account identifier;
identifying a single rewards program account associated with said first payment account identifier;
identifying at least a first conversion rule associated with said single rewards program account and applying said at least first conversion rule to said purchase amount to determine an amount of reward units associated with said first transaction;
retrieving a current reward units balance associated with said single rewards program account;
updating a rewards unit balance associated with said single rewards program account by adding said current reward units balance to said amount of rewards units associated with said first transaction and storing said rewards unit balance in said single rewards program account;
receiving, from a second merchant, data associated with at least a second transaction completed using a second payment card account, said data including a second merchant identifier, a second purchase amount and a second payment account identifier;
identifying said single rewards program account associated with said second payment account identifier;
identifying at least a second conversion rule associated with said single rewards program account and applying said at least second conversion rule to said second purchase amount to determine an amount of reward units associated with said second transaction;
retrieving a current reward units balance associated with said single rewards program account;
updating a rewards unit balance associated with said single rewards program account by adding said current reward units balance to said amount of rewards units associated with said second transaction and storing said rewards unit balance in said single rewards program account; and
transmitting said rewards unit balance to a cardholder associated with said first and second payment accounts.

8. The method of claim 7 wherein said conversion includes identifying a set of conversion rules associated with said single rewards program account and applying an applicable portion of said set of conversion rules to said purchase amount.

9. The method of claim 8 wherein said conversion rules specify at least a first threshold level to be reached in order to earn at least one of a specified reward and a specified amount of loyalty points.

10. The method of claim 7 wherein said first and second payment card accounts each comprise at least one of a credit card account, a debit card account, a stored value account, a health reimbursement account, a health savings account, or a flexible savings account.

11. The method of claim 7 wherein said first and second payment card accounts are held by an individual.

12. The method of claim 7 wherein said first and second payment card accounts are held by at least one of a proprietary small business, partnership, corporation, non-profit or government entity or any employees of said entities.

13. The method of claim 7 wherein a payment card associated with said first and second payment card accounts is at least one of a plastic card embedded with a magnetic stripe, a smart phone, a PDA, a smart card, or a virtual card.

14. The method of claim 7 wherein said merchant operates at least one or more of a physical store, an online website store, or a mail order store

15. A system comprising:
a communications interface to receive transaction information for transactions initiated by multiple payment card accounts associated with a single rewards program account;
logic, communicatively coupled with the communications interface, to administer a rewards program, to link multiple payment card accounts to a single rewards program account, to determine rewards units by applying conversion ratios and rules to the transaction information, to provide access to reward unit balances for redemption requests and to authorize redemption of rewards units by applying redemption rules to the redemption requests;
a data store, communicatively coupled with the logic, to store payment card account rewards information and rewards account information and configured to enable the coupling of multiple payment accounts to a single rewards account.
